(19) United States
(12) Patent Application Publication
(10) Pub. No.: US 2017/0132702 A1
(43) Pub. Date: May 11, 2017

(54) SYSTEMS AND METHODS FOR DISPLAYING CURRENT ORDER PERFORMANCE

(71) Applicant: FIDESSA PLC, London (GB)

(72) Inventors: Bruce Bland, Chesham (GB); Oleh Danyliv, London (GB); Daniel Nicholass, London (GB); Colm Furlong, Brighton & Hove (GB)

(21) Appl. No.: 15/253,088

(22) Filed: Aug. 31, 2016

Related U.S. Application Data
(60) Provisional application No. 62/216,130, filed on Sep. 9, 2015.

(51) Int. Cl. G06Q 40/04

(52) U.S. Cl. CPC G06Q 40/04

(57) ABSTRACT

Systems and methods for the display of information for evaluating performance of a trade order are provided. According to aspects of the disclosure, data corresponding to a pending order to trade a financial instrument is received from an order processing server. Further, data comprising a current value of a performance measurement corresponding to the financial instrument is received from one or more data servers. A graphical object having a length is then displayed on a display device. Next, one or more positions along the length of the displayed graphical object are determined, where each position corresponds to a possible value of the performance measurement. A second graphical object is then displayed at the determined position along the length of the first graphical object that corresponds to the received value of the performance measurement.

### CROSS REFERENCE TO RELATED APPLICATION

This application is related to, and claims priority from, Provisional Patent Application No. 62/216,130, entitled “Display of Current Order Performance,” which was filed on Sep. 9, 2015, the entire contents of which are incorporated by reference herein.

### BACKGROUND

Traders engaged in the trading of market instruments can utilize computer software and hardware tools that provide various graphical user interfaces to display market price data, execute orders, and monitor status of different market conditions. Market instruments can include anything that can be traded in some quantity for a particular price. For example, a market instrument may be goods or financial products (e.g., stocks, bonds, futures, currency, commodities, or other financial instruments). Market instruments may be “real” and listed on an exchange or “synthetic,” such as a combination of real products.

Electronic trading of market instruments has been embraced as the means for buying and selling instruments in various market exchanges throughout the world. Traders can communicate with host computers of the market exchanges or other intermediary host computers coupled with the exchanges via personal computer, mobile device, or any other networked computing platform. Electronic trading allows for display of information regarding market instruments received from the host computer which can impact the decision making process of the trader with regard to placing trade orders. These tools can have a significant impact on trading performance.

Types of information that can impact a trader's decision to trade an instrument include the market price for the instrument, the expected volume of the instrument on the market, the trader's limit price, and generally, the performance of pending or previously executed orders against benchmarks calculated from market data over a period of time. Such benchmarks can include, for example, the volume-weighted average price for the instrument, or the expected volume of the instrument.

The ability to visualize these metrics over time through a graphical user interface can be useful both to traders and their clients in assessing the quality of their investments and informing future order decisions. With the increase in the volume of information available to traders, it is difficult to succinctly, quickly and effectively display trading information, and the large amount of data and ineffective display systems can hamper a trader's productivity and performance. Accordingly, there is a continued need for improved techniques for displaying current order performance.

### SUMMARY

According to aspects of the present disclosure, techniques for displaying current order performance are provided. An example method includes receiving, from an order processing server, first data corresponding to a pending order to trade a financial instrument. The method further includes receiving, from one or more servers, second data comprising a current value of a performance measurement corresponding to the financial instrument, and displaying, on a display, a first graphical object, the first graphical object having a length. The method further includes determining one or more positions along the length of the first graphical object, each position corresponding to a possible value of the performance measurement, and displaying, on the display, a second graphical object at the position along the length of the first graphical object that corresponds to the received value of the performance measurement.

In another aspect of the present disclosure include a system that includes a processor, memory, and display, where the processor is programmed to carry out the above method.

Another aspect of the present disclosure is a non-transitory computer-readable medium that stores instructions that, when executed by a processor, cause the processor to carry out the above method.

### BRIEF DESCRIPTION OF THE DRAWINGS

FIG. 1 a block diagram of a trade order processing system, according to one or more embodiments of the disclosed subject matter.

FIG. 2 depicts a graphical user interface in accordance with an exemplary embodiment of the disclosed subject matter.

FIG. 3 is a flow diagram of a method for rendering a graphical user interface in accordance with one or more embodiments of the disclosed subject matter.

Throughout the drawings, the same reference numerals and characters, unless otherwise stated, are used to denote like features, elements, components or portions of the illustrated embodiments. Moreover, while the disclosed subject matter will now be described in detail with reference to the figures, it is done so in connection with the illustrative embodiments.

### DETAILED DESCRIPTION

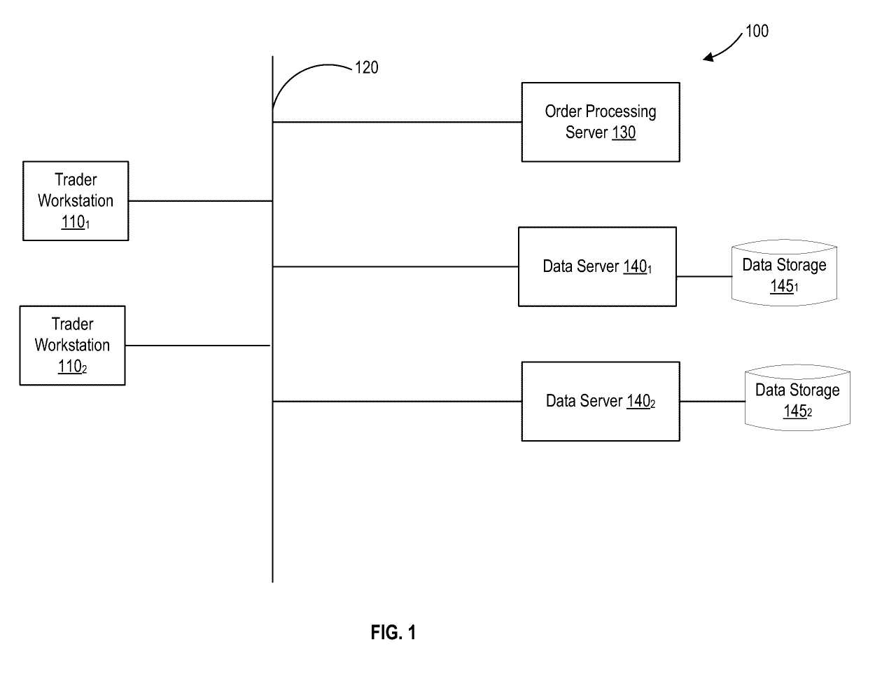

FIG. 1 is a block diagram of a trade order processing system 100, according to one or more embodiments. As shown, trade order processing system 100 includes one or more trader workstations 110. FIG. 1 depicts two trader workstations 110 (i.e., trader workstations 110₁ and 110₂). A trader workstation can be a general purpose computer that includes one or more central processing units, a random access memory (RAM), a local data storage device, a display device, a network adapter to enable network communication, and a keyboard and mouse to enable input of data and commands. Trader workstations are often high-performance desktop computer systems running an operating system such as one of the several generations of the Windows® operating system from Microsoft Corp., or, alternatively, the Linux operating system, or some other commercially-available operating system. However, trader workstations can also be implemented on laptop computers, tablets, and smartphones.

Trader workstations 110₁ and 110₂ are coupled to network 120, which, according to embodiments, is a local area network (LAN) to which a number of computing devices are communicatively coupled. Such a LAN can be, according to embodiments, an Ethernet network, a token ring network, or a token bus network. Alternatively, network 120 can be a campus-wide network that spans multiple buildings, a metropolitan area network (MAN) that connects devices over a larger geographic region, or even a wide area network (WAN) that spans distant cities.

Trade order processing system 100 also includes order processing server 130. Order processing server 130 can be implemented on one or more computer servers, typically high performance computers capable of high throughput transaction processing. Order processing system 130 is also connected to network 120, which enables trader workstations 110₁ and 110₂ to communicate with it. It is contemplated that a trader of financial instruments accesses a trader workstation 110 to submit orders (i.e., buy orders or sell orders) for one or more financial instruments, such as stocks, bonds, futures, or one of a multitude of derivative securities. Once an order is submitted by the trader, the order is transmitted from trader workstation 110 over network 120 to order processing server 130.

Once transmitted to order processing server 130, an order remains pending until it is fulfilled. For example, a buy order is submitted by the trader to purchase a financial instrument at a particular price. When a seller of that financial instrument that is willing to sell the instrument at that price is located, the order is fulfilled and is no longer pending. This locating of a willing seller of the financial instrument can be performed by order processing server 130 or, alternatively, can be performed by a separate fulfillment system (not shown in FIG. 1).

As depicted in FIG. 1, trade order processing system 100 also includes one or more data servers 140. As is the case for order processing server 130, each data server 140 can be a high-performance transaction server. Alternatively, data servers 140 can also be general purpose desktop computers, laptop computers. Each data server 140 is coupled to a data storage device 145. Data storage device 145 can be an internal or external disk drive capable of storing large quantities of data. Alternativley, data storage device 145 can be a large-scale storage array or storage area network. Data storage 145 can be stored as part of a local network, a cloud-based network, or otherwise store anything such that it is accessible by data servers 140 (for example, and without limitation, data storage 145 could instead be coupled to network 120 and accessible by multiple other elements also communicatively coupled to network 120, or the data described herein as stored on data storage 145 could be stored locally on the same computers as data servers 140, order processing server 130, or otherwise). Data servers 140 store data and metrics relating to, for example, the order performance financial instruments. For example, data servers 140 can store (on data storage devices 145) the average market price for a particular financial instrument over some predetermined time period such as, for example, the time that a current order to buy or sell the financial instrument has been pending on order processing server 130. Other metrics that can be stored by data servers 140 are the volume weighted average price (VWAP) of certain financial instruments over a predetermined time period, the last price at which an order for a financial instrument has been filled, and the last quoted market price for a financial instrument.

As shown in FIG. 1, order processing server 130 is communicatively coupled to data servers 140 over network 120. Thus, the aforementioned performance metrics can be computed or otherwise determined by order processing server 130 and transmitted over network 120 for storage at data servers 140. In this way, data servers 140 are capable of storing both current and historical order performance metrics.

Further, trader workstations 110 are also communicatively coupled over network 120 to data servers 140. Thus, trader workstations 110 can access and/or retrieve stored order performance metrics and display these metrics in a graphical user interface (GUI) on the display device attached to the workstation. This enables a trader to determine an optimal strategy for pending and future orders for financial instruments.

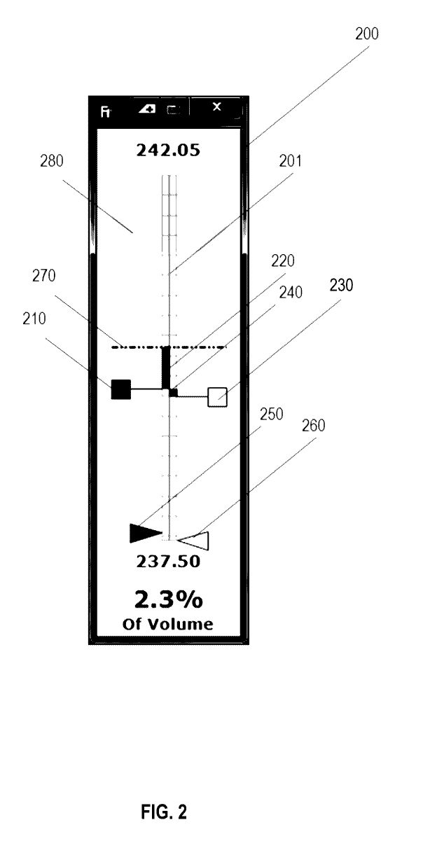

FIG. 2 illustrates a graphical user interface in accordance with an exemplary embodiment of the disclosed subject matter. Referring to FIG. 2, for the purpose of illustrating a non-limiting embodiment, the disclosed subject matter can include the generation of a GUI 200 corresponding to a trade order for a financial instrument. The GUI can include one or more central bars 201 that have a scale set to an appropriate high and low price. The high and low price can be, for example, the high and low traded price for the financial instrument for the day. For example, and not limitation, the scale of central bar 201 as depicted in FIG. 1 has a scale set to a high price of $242.05 and a low price of $237.50.

The GUI can include moving markers (210, 230, 250, 260) rendered such that their placing in relation to the central bar(s) can illustrate metrics corresponding to the pending order to which the GUI corresponds. For example, in an exemplary embodiment, four moving markers (210, 230, 250, 260) can be rendered to illustrate the last fill price for the order, the average fill price for the order, the price of last execution for the order instrument, and the Volume Weighted Average Price (VWAP) for the order instrument in the order lifetime. In an exemplary embodiment, and as depicted in FIG. 2, the markers can include: the average price per share for order (210); the VWAP price of the market 230; the last fill price for the order 250; and the last traded price for the market 260.

In an exemplary embodiment, at least one of the central bars can be colored or shaded to emphasize the price difference between the order average price and appropriate market benchmarks. For example, green 220 can indicate good performance of the last fill price against the benchmark and red 240 can indicate poor performance of the average fill price against the benchmark. Such benchmarks can include, for example, the past or present volume-weighted average price for the instrument, the expected volume of the instrument. Other additional benchmarks can include, for example, time weighted average price (TWAP), Mid, Open, or Close price. Additionally and/or alternatively, the average order fill price and last order fill price markers can be colored to represent the order direction.

In certain embodiments, additional market benchmarks (such as arrival as shown in FIG. 2) can be displayed by the use of, for example, a dashed line 270 intersecting the central bar at the appropriate point. Price regions in which the order would be untradeable 280 can be illustrated by the use of different background coloring. The untradeable region can, for example in connection with FIG. 2, be caused by a buy order where the limit price restricts prices for which it can be executed. Additional information such as order volume participation can be displayed around the central bar. Order volume participation can be computed, for example, based on the trades which occurred on the market during the lifetime of the order and the limit price on the order.

The disclosed subject matter can also allow traders to monitor the performance of a pending order with a single graphical user interface that can quickly and efficiently relay key information to traders working within a time-sensitive trading environment. Using the techniques disclosed herein, traders can more effectively and efficiently assess the quality of their investments and take action accordingly. Additionally, the techniques disclosed here can provide traders with a visual representation of order performance that can be used to guide and expedite future order decisions. The quick assessment of trading performance can be vital when monitoring numerous orders being traded by multiple algorithms within a trading platform. For example, orders performing badly can be routed to a trader if performance is poor.

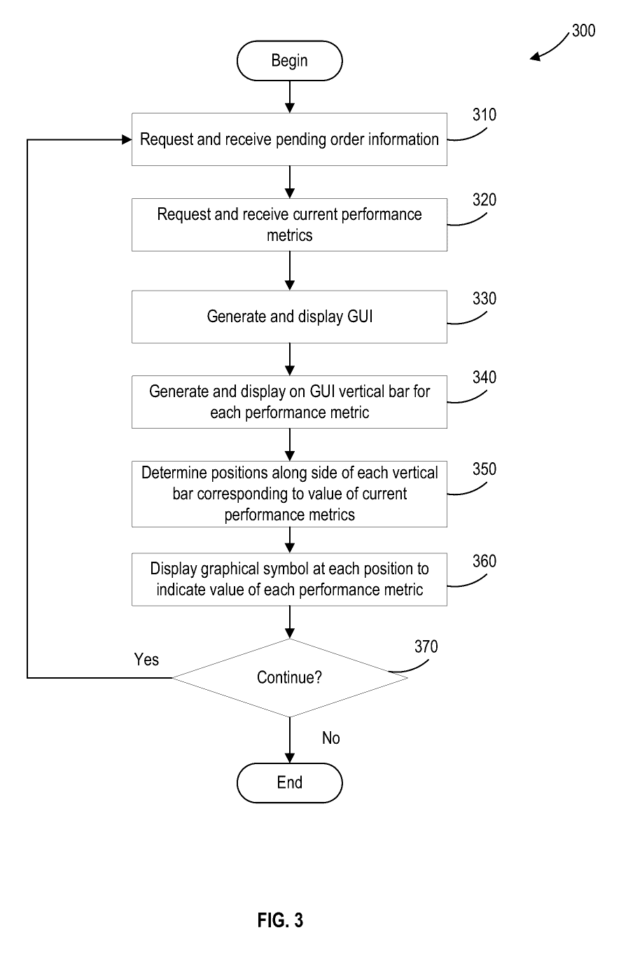

FIG. 3 is a flow diagram of a method 300 for rendering a GUI in accordance with one or more embodiments of the disclosed subject matter. Method 300 can be implemented as one or more computer programs that execute as one or more processes on a trader workstation, such as trader workstations 110 depicted in FIG. 1.

Method 300 begins at step 310, where the method requests and receives pending order information corresponding to a financial instrument. As mentioned above, when a trader submits an order to either buy or sell a financial instrument, according to one or more embodiments, that order is submitted to an order processing server where the order is held in a pending state until it is fulfilled. The pending order information includes at least an identifier for the corresponding financial instrument. The pending order information can also include the size of the current order (such as, for example, the number shares of stock to be bought or sold), a limit price at which the order is targeted to be fulfilled, or a preferred counterparty. The request can be transmitted from the trader workstation (such as trader workstations 110) to order processing server 130, which, in response, sends the pending order information back to the requester.

Method 300 then proceeds to step 320. At step 320, the method requests and receives one or more current performance metrics corresponding to the financial instrument. For example, as mentioned above, performance metrics can include an average fill price for past orders for the financial instrument (either buy or sell orders), a most recent fill price for the financial instrument, a volume weighted average price of past orders for the financial instrument, or other price-based metrics corresponding to the financial instrument. According to one or more embodiments, the trader workstation (such as trader workstations 110) transmits one or more requests to one or more of data servers 140. The request can include an identifier for the financial instrument that corresponds to the pending order. The request can also include information that identifies one or more types of performance metrics (such as, for example, average fill price and VWAP). Data servers 140, upon receiving the request, then retrieve or compute one or more of the requested performance metrics. For example, in one embodiment, data servers 140 can compute the performance metrics at the time they are requested. In other embodiments, data servers 140 can pre-compute the performance metrics periodically and store them in a database in one or more of data storage devices 145. After retrieving or computing the requested performance metrics, data server 140 transmits this information back to the requesting trader workstation 110.

In addition, according to some embodiments, data servers 140 transmit, in addition to the requested performance metrics, a range (i.e., a maximum and a minimum value) that the performance metric has taken on (or is likely to take on) during a predetermined time period. For example, data servers 140 can receive a request for an average fill price during the pendency of the current outstanding trade order for a financial instrument. In addition to sending the current average fill price (i.e., the average fill price for orders during the pendency of the order), data servers 140 can also send a maximum and minimum average fill price during that same time period (or during previous time periods). The range information enables trader workstation to construct a GUI that enables a trader to view, in perspective, the current order performance metric for the financial instrument, as will be explained below.

Further, in some embodiments, data servers 140 transmit various benchmark values or benchmark ranges. These benchmarks are used to enable the trader to view current order performance in relation to certain relevant market benchmarks (such as volume weighted average price or current volume), and to thereby allow the trader to assess the performance of the financial instrument against these benchmarks. In addition, data servers 140 can also compute and transmit a second range of values (that is a subset of the minimum and maximum values previously mentioned) at which the pending order is unlikely to be filled, or for which the financial instrument is considered to be untradeable.

Once the trader workstation receives the current performance metrics for the financial instruments (and, for some embodiments, the aforementioned ranges and benchmarks), method 300 proceeds to step 330. At step 330, method 300 constructs and renders, on the display of trader workstation 110, a GUI. This can be accomplished by trader workstation 110 executing a process or thread that creates and displays the window, such as the processes that control windowing under any one of variations of the Microsoft Windows operating system. When first rendered, the GUI can be a window having controls that are responsive to mouse or keyboard interactions. For example, in some embodiments, the window includes pulldown menus, icons that, when selected, minimize or maximize the window on the display, and an icon that, when selected, “closes” (i.e., deletes) the window from the display, and stops execution of the window process on trader workstation 110. Notably, the present invention is not so limited as to this particular and exemplary method for rendering the GUI; other methods, including remotely rendered X-Windows systems, GUIs created using Java graphics APIs (such as Abstract Window Toolkit and Swing), and touch sensitive GUIs rendered on mobile devices are all contemplated and within the scope of the present disclosure.

At step 340, method 300 generates, according to one or more embodiments, a vertical bar for each of the performance metrics received at step 320. The length of each of the vertical bars corresponds to a range of values that the performance metric has taken on (or can potentially take on) during a predetermined past or future time period. For example, as shown in FIG. 2, central bar 201 is scaled so that the minimum and maximum values of the performance metrics are $237.50 and $242.50, respectively. In the case of FIG. 2, the displayed performance metrics correspond to average price per share (210), VWAP (230), last fill price for the financial instrument whose order is currently pending (250), and the last trade price on the market for the financial instrument (260). It should be noted that a single vertical bar can be displayed, where the single bar corresponds to all of the received performance metrics. However, in some embodiments, method 300 displays a separate vertical bar for each of the received metrics. This is done, for example, in order enable easier viewing of the separate metrics, or, in other cases, where the unit of measure of two different performance metrics is different (for example, price for a first metric, and volume for a second metric).

Further, as illustrated in FIG. 2, the sides of the displayed vertical bars can be divided into points that are equidistant from one another, where each of the points represents a possible value of the performance metric within the given range. Referring again to FIG. 2, central bar 201 is divided into discrete points that the aforementioned performance metrics can take on, ranging between $237.50 and $242.05.

As part of displaying the vertical bars, method 300 can also shade certain regions of the vertical bars that correspond to one or more benchmarks received at step 320. For example, in FIG. 2, shaded region 220 corresponds to a range of price values over which performance of the financial instrument is considered to be acceptable in view of the benchmark. In addition, shaded region 220 can be displayed in different colors, where each color is an indicator of performance against the benchmark. For example, if shaded region 220 is colored green, this would indicate that the financial instrument is performing well against the benchmark in that price range. Likewise, if shaded region 220 is colored red, this would indicate that the financial instrument is performing poorly against the benchmark. Further, method 300 can indicate visually other regions (i.e., price ranges) for which the financial instrument is considered untradeable. Notably, the present invention is not limited to only these particular colors or configurations, but instead the present invention could be employed by one of ordinary skill in the art to present the data to a trader in a variety of different ways that would accomplish the objectives of the invention herein. In FIG. 2, the untradeable price range for the financial instrument is represented as region 280.

Next, at step 350, method 300 determines one or more positions along the side of each of the displayed vertical bars that correspond to the value current performance metric received at step 320. For example, as shown in FIG. 2, the value of the last traded price for the financial instrument is $237.50. Thus, method 300 determines a position along the side of central bar 201 that corresponds to this value of the last traded price. In FIG. 2, this position corresponds to point that is lowest on the displayed vertical bar (i.e., the minimum price).

At step 360, method 300 displays at the determined positions graphical symbols that visually identify each of the current performance metrics received at step 320. Thus, referring again to FIG. 2, square maker 210 is displayed at the position along the side of central bar 201 that corresponds to the average price per share for the financial instrument for which there is a pending order. Likewise, triangular marker 250 is displayed at the position along the side of central bar 201 that corresponds to the last fill price for the financial instrument for which there is a pending order. Other symbols displayed at appropriate positions along the sides central bar 201 are the VWAP of the financial instrument (230) and the last traded price of the financial instrument (260).

At step 370, method 300 determines whether to continue. If the method is to continue, the method returns to step 310, where the current order information for the financial instrument is again requested. Steps 320-360 are also repeated. This enables the GUI to take on a dynamic character. For example, if the current values of the various requested performance metrics change, then the positions at which the graphical symbols are displayed alongside the vertical bars also change. In this way, the graphical symbols are moved from one position to another along the side of the vertical bar. This gives the GUI the appearance of a dynamic market “dashboard,” that enables a trader to visualize, in real time, order performance of a financial instrument, thereby allowing the trader to make more informed trading decisions.

If, however, at step 370, method 300 determines that it is not to continue, then method 300 terminates.

Although one or more embodiments have been described herein in some detail for clarity of understanding, it should be recognized that certain changes and modifications can be made without departing from the spirit of the disclosure. The embodiments described herein can employ various computer-implemented operations involving data stored in computer systems. For example, these operations can require physical manipulation of physical quantities—usually, though not necessarily, these quantities can take the form of electrical or magnetic signals, where they or representations of them are capable of being stored, transferred, combined, compared, or otherwise manipulated. Further, such manipulations are often referred to in terms, such as producing, yielding, identifying, determining, or comparing. Any operations described herein that form part of one or more embodiments of the disclosure can be useful machine operations. In addition, one or more embodiments of the disclosure also relate to a device or an apparatus for performing these operations. The apparatus can be specially constructed for specific required purposes, or it can be a general purpose computer selectively activated or configured by a computer program stored in the computer. In particular, various general purpose machines can be used with computer programs written in accordance with the teachings herein, or it can be more convenient to construct a more specialized apparatus to perform the required operations.

The embodiments described herein can be practiced with other computer system configurations including hand-held devices, microprocessor systems, microprocessor-based or programmable consumer electronics, minicomputers, mainframe computers, and the like.

One or more embodiments of the present disclosure can be implemented as one or more computer programs or as one or more computer program modules embodied in one or more computer readable media. The term computer readable medium refers to any data storage device that can store data which can thereafter be input to a computer system—computer readable media can be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Disc), a CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present disclosure have been described in some detail for clarity of understanding, it will be apparent that certain changes and modifications can be made within the scope of the claims. Accordingly, the described embodiments are to be considered as illustrative and not restrictive, and the scope of the claims is not to be limited to details given herein, but can be modified within the scope and equivalents of the claims. In the claims, elements do not imply any particular order of operation, unless explicitly stated in the claims.

Many variations, modifications, additions, and improvements can be made. Plural instances can be provided for components, operations or structures described herein as a single instance. Boundaries between various components, operations and data stores are somewhat arbitrary, and particular operations are illustrated in the context of specific illustrative configurations. Other allocations of functionality are envisioned and can fall within the scope of the disclosure(s). In general, structures and functionality presented as separate components in exemplary configurations can be implemented as a combined structure or component. Similarly, structures and functionality presented as a single component can be implemented as separate components. These and other variations, modifications, additions, and improvements can fall within the scope of the appended claim(s).

What is claimed is:

1. A method for displaying information for evaluating performance of a trade order, comprising:
receiving, from an order processing server, first data corresponding to a pending order to trade a financial instrument;
receiving, from one or more data servers, second data comprising a current value of a performance measurement corresponding to the financial instrument;
displaying, on a display, a first graphical object, the first graphical object having a length;
determining one or more positions along the length of the first graphical object, each position corresponding to a possible value of the performance measurement; and
displaying, on the display, a second graphical object at the position along the length of the first graphical object that corresponds to the received value of the performance measurement.

2. The method of claim 1, wherein the second data further comprises a minimum value of the performance measurement and a maximum value of the performance measurement, and
wherein the method further comprises:
displaying, at a first end of the first graphical object, the minimum value of the performance measurement; and
displaying, at a second end of the first graphical object, the maximum value of the performance measurement.

3. The method of claim 1, wherein the second data further comprises at least one benchmark value corresponding to the financial instrument, and
wherein the method further comprises:
comparing the received value of the performance measurement with the benchmark value; and
changing a visual characteristic of the first graphical object based on the comparison.

4. The method of claim 1, wherein each of the positions along the length of the first graphical object represents a price of the financial instrument, and
wherein the method further comprises:
determining one or more prices for which the trade order will not be executed;
changing a visual characteristic of a region of the first graphical object, the region spanning the positions along the first graphical object that correspond to the prices at which the trade order will not be executed.

5. The method of claim 1, wherein the performance measurement corresponding to the financial instrument is one of the average price of the financial instrument over a predetermined time period, the volume weighted average price of the financial instrument over a predetermined time period, a most recent price of the financial instrument at which a trade order for the financial instrument was executed, and the most recent traded price for the financial instrument.

6. The method of claim 1, wherein the first graphical object is a vertical bar and the second graphical object is a triangle whose vertex is displayed adjacent to the first graphical object.

7. The method of claim 1, further comprising:
waiting a predetermined amount of time;
receiving, from the one or more data servers, an updated value of the performance measurement corresponding to the financial instrument; and
moving, on the display, the second graphical object to the position along the length of the first graphical object that corresponds to the updated value of the performance measurement.

8. A system, comprising:
a processor;
a memory; and
a display, wherein the processor is programmed to carry out a method for displaying information for evaluating performance of a trade order, the method comprising:
receiving, from an order processing server, first data corresponding to a pending order to trade a financial instrument;
receiving, from one or more data servers, second data comprising a current value of a performance measurement corresponding to the financial instrument;
displaying, on a display, a first graphical object, the first graphical object having a length;
determining one or more positions along the length of the first graphical object, each position corresponding to a possible value of the performance measurement; and
displaying, on the display, a second graphical object at the position along the length of the first graphical object that corresponds to the received value of the performance measurement.

9. The system of claim 8, wherein the second data further comprises a minimum value of the performance measurement and a maximum value of the performance measurement, and
wherein the method further comprises:
displaying, at a first end of the first graphical object, the minimum value of the performance measurement; and
displaying, at a second end of the first graphical object, the maximum value of the performance measurement.

10. The system of claim 8, wherein the second data further comprises at least one benchmark value corresponding to the financial instrument, and
wherein the method further comprises:
comparing the received value of the performance measurement with the benchmark value; and
changing a visual characteristic of the first graphical object based on the comparison.

11. The system of claim 8, wherein each of the positions along the length of the first graphical object represents a price of the financial instrument, and
wherein the method further comprises:
determining one or more prices for which the trade order will not be executed;
changing a visual characteristic of a region of the first graphical object, the region spanning the positions along the first graphical object that correspond to the prices at which the trade order will not be executed.

12. The system of claim 8, wherein the performance measurement corresponding to the financial instrument is one of the average price of the financial instrument over a predetermined time period, the volume weighted average price of the financial instrument over a predetermined time period, a most recent price of the financial instrument at which a trade order for the financial instrument was executed, and the most recent traded price for the financial instrument.

13. The system of claim 8, wherein the first graphical object is a vertical bar and the second graphical object is a triangle whose vertex is displayed adjacent to the first graphical object.

14. The system of claim 8, further comprising:
waiting a predetermined amount of time;
receiving, from the one or more data servers, an updated value of the performance measurement corresponding to the financial instrument; and
moving, on the display, the second graphical object to the position along the length of the first graphical object that corresponds to the updated value of the performance measurement.

15. A non-transitory computer readable medium that stores instruction that, when executed by a processor, cause the processor to carry out a method for displaying information for evaluating performance of a trade order, the method comprising:
receiving, from an order processing server, first data corresponding to a pending order to trade a financial instrument;
receiving, from one or more data servers, second data comprising a current value of a performance measurement corresponding to the financial instrument;
displaying, on a display, a first graphical object, the first graphical object having a length;
determining one or more positions along the length of the first graphical object, each position corresponding to a possible value of the performance measurement; and
displaying, on the display, a second graphical object at the position along the length of the first graphical object that corresponds to the received value of the performance measurement.

16. The non-transitory computer readable medium of claim 15, wherein the second data further comprises a minimum value of the performance measurement and a maximum value of the performance measurement, and
wherein the method further comprises:
displaying, at a first end of the first graphical object, the minimum value of the performance measurement; and
displaying, at a second end of the first graphical object, the maximum value of the performance measurement.

17. The non-transitory computer readable medium of claim 15, wherein the second data further comprises at least one benchmark value corresponding to the financial instrument, and
wherein the method further comprises:
comparing the received value of the performance measurement with the benchmark value; and
changing a visual characteristic of the first graphical object based on the comparison.

18. The non-transitory computer readable medium of claim 15, wherein each of the positions along the length of the first graphical object represents a price of the financial instrument, and
wherein the method further comprises:
determining one or more prices for which the trade order will not be executed;
changing a visual characteristic of a region of the first graphical object, the region spanning the positions along the first graphical object that correspond to the prices at which the trade order will not be executed.

19. The non-transitory computer readable medium of claim 15, wherein the performance measurement corresponding to the financial instrument is one of the average price of the financial instrument over a predetermined time period, the volume weighted average price of the financial instrument over a predetermined time period, a most recent price of the financial instrument at which a trade order for the financial instrument was executed, and the most recent traded price for the financial instrument.

20. The non-transitory computer readable medium of claim 15, wherein the first graphical object is a vertical bar and the second graphical object is a triangle whose vertex is displayed adjacent to the first graphical object.
